(19) United States
(12) Patent Application Publication
(10) Pub. No.: US 2012/0215714 A1
(43) Pub. Date: Aug. 23, 2012

(54) E-FREIGHT PROCESSING FOR AIR WAYBILLS

(75) Inventors: William Loebertmann, Shakopee, MN (US); JoAnn Jancik, Victoria, MN (US)

(73) Assignee: Unisys Corp., Blue Bell, PA (US)

(21) Appl. No.: 13/032,869

(22) Filed: Feb. 23, 2011

(51) Int. Cl. G06Q 10/00

(52) U.S. Cl. 705/331

(57) ABSTRACT

Electronic processing of the paper air waybills improves the speed and reduces the cost of providing air waybills. Enhanced services available for e-freight air waybills include automatic locking of the air waybills and automatic export quality assurance. E-freight air waybills may be identified by special handling codes such as e-Freight Air Waybill with Paper Document (EAP) and e-Freight Air Waybill without Paper Document (EAW). Additionally, an air waybill history may be created for the e-freight air waybills. The history may include freight waybill (FWB) messages and freight negative acknowledgement (FNA) messages related to the e-freight air waybill.

### TECHNICAL FIELD

The instant disclosure relates to air waybills. The instant disclosure more specifically relates to electronic processing of air waybills.

### BACKGROUND

Air waybills are conventionally stored as paper copies. Paper air waybills consume a significant amount of manual labor to process, record, and store information regarding the air waybill. The manual labor results in increased cost and slower response times to changes in the air waybills. Thus, there is a need for electronic processing of the paper air waybills.

### SUMMARY

According to one embodiment, a method includes receiving a freight waybill (FWB) message for an air waybill for a shipment. The method also includes determining if the air waybill has a special handling code indicating the air waybill is an e-freight air waybill. The method further includes when the air waybill is an e-freight air waybill processing the e-freight air waybill according to the received FWB message without locking the e-freight air waybill. The method also includes locking the e-freight air waybill when the shipment is accepted by a receiver.

According to another embodiment, a computer program product includes a computer-readable medium having code to receive a freight waybill (FWB) message for an air waybill for a shipment. The medium also includes code to determine if the air waybill has a special handling code indicating the air waybill is an e-freight air waybill. The medium further includes code to, when the air waybill is an e-freight air waybill, process the e-freight air waybill according to the received FWB message without locking the e-freight air waybill. The medium also includes code to lock the e-freight air waybill when the shipment is accepted by a receiver.

According to yet another embodiment, an apparatus includes a processor and a memory coupled to the processor, in which the processor is configured to receive a freight waybill (FWB) message for an air waybill for a shipment. The processor is also configured to determine if the air waybill has a special handling code indicating the air waybill is an e-freight air waybill. The processor is further configured to, when the air waybill is an e-freight air waybill, process the e-freight air waybill according to the received FWB message without locking the e-freight air waybill. The processor is also configured to lock the e-freight air waybill when the shipment is accepted by a receiver.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a flow chart illustrating automatic processing of an e-freight air waybill according to one embodiment of the disclosure.

FIG. 2 is a block diagram illustrating a system for processing an e-freight air waybill according to one embodiment of the disclosure.

FIG. 3 is a block diagram illustrating a data management system configured to store e-freight air waybills according to one embodiment of the disclosure.

FIG. 4 is a block diagram illustrating a server according to one embodiment of the disclosure.

### DETAILED DESCRIPTION

Conventional paper air waybill processing may be adapted to allow electronic processing of e-freight air waybills. For example, servers storing and processing the e-freight air waybills may include support for processing freight waybill (FWB) messages, freight negative acknowledgement (FNA) messages, and status (FSU) messages. Electronically processing these messages on e-freight air waybills reduces the manual labor performed by airline staff handling the paper air waybills.

According to one embodiment, an air waybill history may be stored and processed for e-freight air waybills. The air waybill history stores and displays received CargoIMP freight waybill (FWB) messages, rejected FWBs, and outgoing freight negative acknowledgement (FNA) messages. The air waybill history may include an entry for each received FWB message received regardless of whether a corresponding air waybill exists. Information stored in the air waybill history for each FWB message may include an action, a user id, a station, a PID, a date, and a time. The PID may indicate one or more of an accept goods (GAC) code, enter goods information (EGI) code, an airline flight manifest message (FFM) code, and/or an enter goods discrepancy (EGD) code.

If a FWB message is received for processing and the air waybill associated with the FWB message does not exist in an air waybill database, a status-only air waybill may be created for storing rejected FWB messages resulting in an FNA message. The status only air waybill may include a purge data indicating the air waybill will be deleted unless another event occurs referring to the air waybill. For example, if a booking is created, goods are created, or shipment data capture is completed for a status-only air waybill, the air waybill may become an e-freight air waybill.

Alternatively, the received FWB message may be placed in an error queue. A parameter in a software application may specify whether users may edit an FNA message returned after receiving and rejecting an FWB message. For example, when the parameter is one value the user is not allowed to edit the FNA message and the FNA message is sent automatically with a default value for rejection remarks in the FNA message. In another example, the parameter may specify a value indicating a FWB reject remark popup may be displayed to a user allowing the user to enter a remark for the rejection remarks in the FNA message. The FNA message may also include information such as an action, a user id, a station, a date, and a time. According to one embodiment, FNA messages may be recorded in the air waybill history with FWB messages.

An e-freight air waybill and associated e-freight FWB messages may have enhancements over conventional air waybills. An air waybill may include an indication that the air waybill is an e-freight air waybill. For example, the air waybill may be identified as an e-Freight Air Waybill with Paper Document (EAP) or the air waybill may be identified as an e-Freight Air Waybill without Paper Document (EAW).

When an air waybill is identified as an e-freight air waybill the air waybill may be processed by the server. According to one embodiment, the air waybill may be automatically locked. According to another embodiment, the air waybill may have automatic export quality assurance (EQA).

An e-freight air waybill may be automatically locked when an FWB message is processed and shipment data capture is completed. For example, when the shipment is received and accepted by a receiver the e-freight air waybill may be automatically locked. After the e-freight air waybill is locked, additional FWB messages received regarding the e-freight air waybill may be automatically rejected. After the receiver accepts the shipment, the e-freight air waybill may be considered a cargo receipt or a legal air waybill.

According to one embodiment, when the e-freight air waybill is locked an entry may be created in the air waybill history including a code indicating the reason for locking the e-freight air waybill. For example, “FWB” may indicate FWB processing has locked the air waybill, “GAC” may indicate an accept goods function or an incoming FSU RCS has locked the air waybill, “EGI” may indicate a goods information function has locked the air waybill, “FFM” may indicate an incoming FFM message has locked the air waybill, “EFM” may indicate an enter flight manifest function has locked the air waybill, or “EGD” may indicate a goods discrepancy function has locked the air waybill.

According to one embodiment, when goods are not created from an incoming status message (FSU) of the shipment received from shipper (RCS) status, a server may maintain a non-goods pieces counter of the total goods pieces associated with the e-freight air waybill. This counter may be used in a set of rules for locking the e-freight air waybill for those stations that only record the incoming FSU RCS message in a goods history and do not attempt to create goods. In one example a rule may automatically lock an e-freight air waybill when goods already exist for the air waybill and an FWB message is successfully processed if the air waybill is not on any air waybill management queue and not on a terminal discrepancy queue and if the total goods pieces at an export reporting station match or exceed the total air waybill pieces. In another example, a rule may automatically lock an e-freight air waybill when shipment data capture is complete from successful FWB processing and goods are being created or goods are recorded as received by an incoming FSU RCS message if the air waybill is not on any air waybill management queue and not on the terminal discrepancy queue and if the total goods pieces at the export reporting station match or exceed the total air waybill pieces.

An e-freight air waybill may also have automatic export quality assurance (EQA). For example, an e-freight shipment, identified by a special handling code of EAP or EAW, may be processed by automatic EQA even when the user id participant is not allowed for automatic EQA.

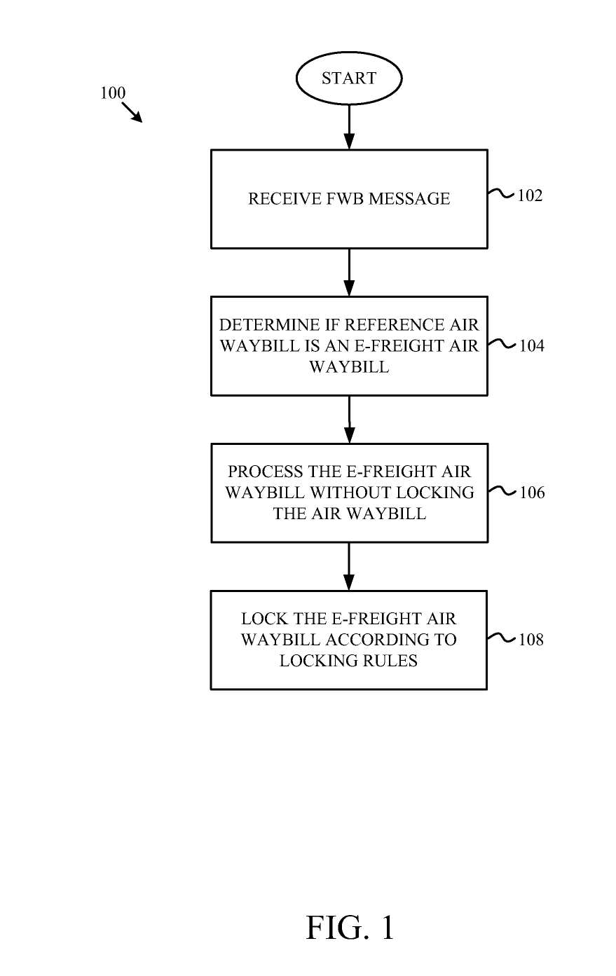

FIG. 1 is a flow chart illustrating automatic processing of an e-freight air waybill according to one embodiment of the disclosure. A flow chart 100 begins at block 102 with receiving a FWB message. At block 104 an air waybill identified by the FWB message may be determined to be an e-freight air waybill. At block 106 the e-freight air waybill is processed without locking the air waybill. At block 108 the e-freight air waybill is locked according to locking rules. For example, after a shipment specified in the e-freight air waybill is accepted by a receiver the e-freight air waybill may be locked.

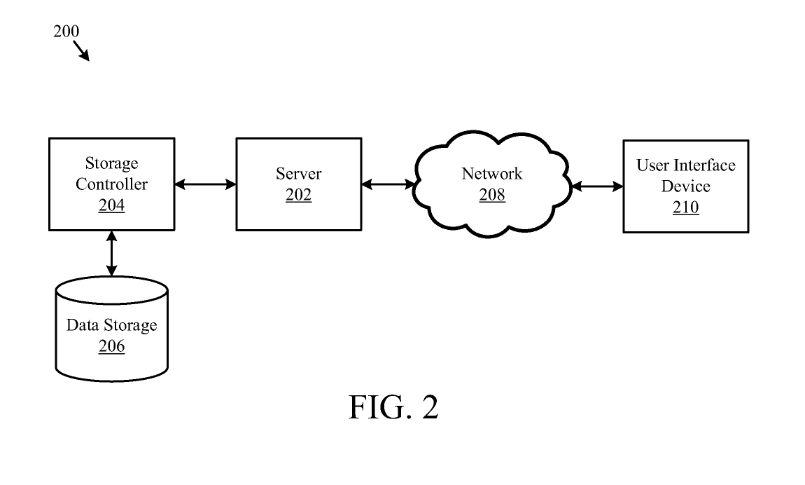

FIG. 2 illustrates one embodiment of a system 200 for processing e-freight air waybills. The system 200 may include a server 202, a data storage device 206, a network 208, and a user interface device 210. In a further embodiment, the system 200 may include a storage controller 204, or storage server configured to manage data communications between the data storage device 206, and the server 202 or other components in communication with the network 208. In an alternative embodiment, the storage controller 204 may be coupled to the network 208.

In one embodiment, the user interface device 210 is referred to broadly and is intended to encompass a suitable processor-based device such as a desktop computer, a laptop computer, a personal digital assistant (PDA) or table computer, a smartphone or other a mobile communication device or organizer device having access to the network 208. In a further embodiment, the user interface device 210 may access the Internet or other wide area or local area network to access a web application or web service hosted by the server 202 and provide a user interface for enabling a user to enter or receive information about e-freight air waybills.

The network 208 may facilitate communications of data between the server 202 and the user interface device 210. The data may include other charge information related to air waybills. The network 208 may include any type of communications network including, but not limited to, a direct PC-to-PC connection, a local area network (LAN), a wide area network (WAN), a modem-to-modem connection, the Internet, a cellular network, a combination of the above, or any other communications network now known or later developed within the networking arts which permits two or more computers to communicate, one with another.

In one embodiment, the user interface device 210 access the server 202 through an intermediate sever (not shown). For example, in a cloud application the user interface device 210 may access an application server. The application server fulfills requests from the user interface device 210 by accessing a database management system (DBMS). In this embodiment, the user interface device 210 may be a computer executing a Java application making requests to a JBOSS server executing on a Linux server, which fulfills the requests by accessing a relational database management system (RDMS) on a mainframe server. For example, the JBOSS server may receive other charge rules from a Java application executing on client workstation or mobile device. The JBOSS server may retrieve air waybills from the mainframe server.

In one embodiment, the server 202 is configured to store e-freight air waybills. Additionally, scripts on the server 202 may access data stored in the data storage device 206 via a Storage Area Network (SAN) connection, a LAN, a data bus, or the like. The data storage device 206 may include a hard disk, including hard disks arranged in an Redundant Array of Independent Disks (RAID) array, a tape storage drive comprising a physical or virtual magnetic tape data storage device, an optical storage device, or the like. The data may be arranged in a database and accessible through Structured Query Language (SQL) queries, or other data base query languages or operations.

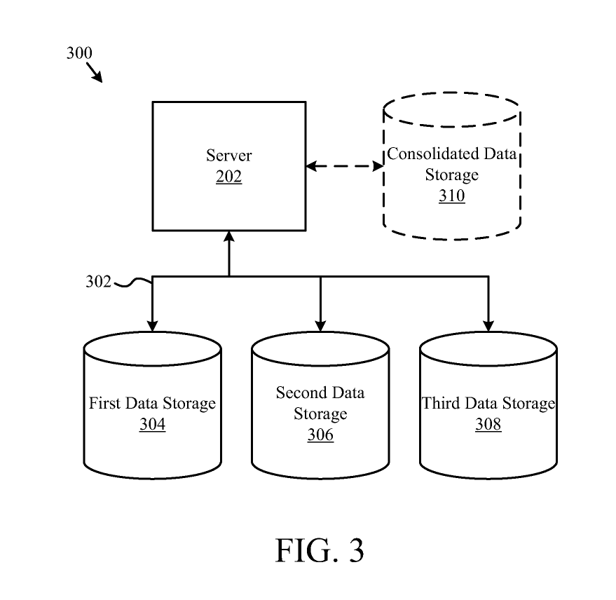

FIG. 3 illustrates one embodiment of a data management system 300 configured to provide access to e-freight air waybills. In one embodiment, the data management system 300 may include a server 202. The server 202 may be coupled to a data-bus 302. In one embodiment, the data management system 300 may also include a first data storage device 304, a second data storage device 306, and/or a third data storage device 308. In further embodiments, the data management system 300 may include additional data storage devices (not shown). In such an embodiment, each data storage device 304, 306, 308 may each host a separate database that may, in conjunction with the other databases, contain redundant data. Alternatively, the storage devices 304, 306, 308 may be arranged in a RAID configuration for storing a database or databases through may contain redundant data.

In one embodiment, the server 202 may submit a query to selected data from the storage devices 304, 306. The server 202 may store consolidated data sets in a consolidated data storage device 310. In such an embodiment, the server 202 may refer back to the consolidated data storage device 310 to obtain an air waybill. Alternatively, the server 202 may query each of the data storage devices 304, 306, 308 independently or in a distributed query to obtain the air waybill. In another alternative embodiment, multiple databases may be stored on a single consolidated data storage device 410.

In various embodiments, the server 202 may communicate with the data storage devices 304, 306, 308 over the data-bus 302. The data-bus 302 may comprise a SAN, a LAN, or the like. The communication infrastructure may include Ethernet, Fibre-Chanel Arbitrated Loop (FC-AL), Small Computer System Interface (SCSI), Serial Advanced Technology Attachment (SATA), Advanced Technology Attachment (ATA), and/or other similar data communication schemes associated with data storage and communication. For example, the server 202 may communicate indirectly with the data storage devices 304, 306, 308, 310; the server 202 first communicating with a storage server or the storage controller 204.

The server 202 may include modules for interfacing with the data storage devices 304, 306, 308, 310, interfacing a network 208, interfacing with a user through the user interface device 210, and the like. In a further embodiment, the server 202 may host an engine, application plug-in, or application programming interface (API).

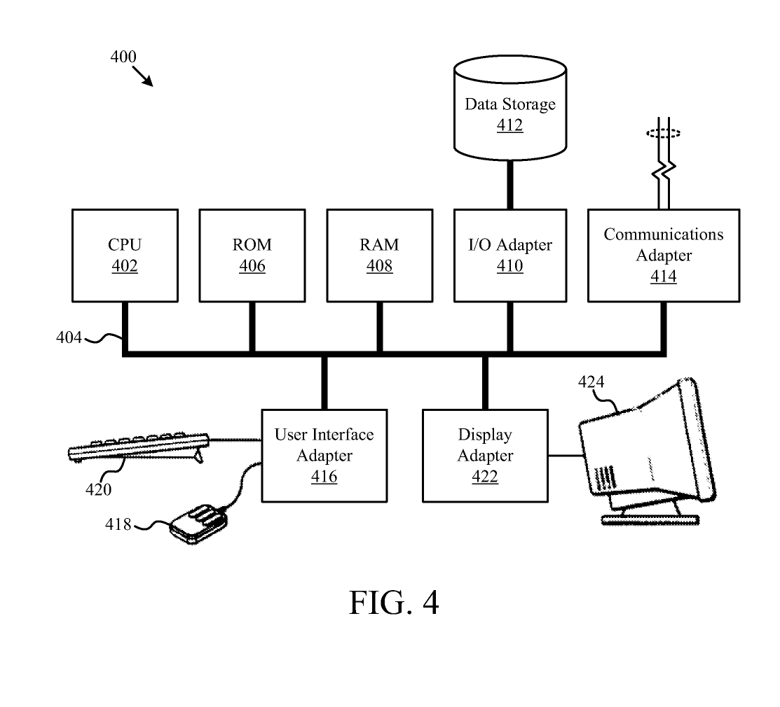

FIG. 4 illustrates a computer system 400. The central processing unit (“CPU”) 402 is coupled to the system bus 404. The CPU 402 may be a general purpose CPU or microprocessor, graphics processing unit (“GPU”), microcontroller, or the like. The present embodiments are not restricted by the architecture of the CPU 402 so long as the CPU 402, whether directly or indirectly, supports the modules and operations as described herein. The CPU 402 may execute the various logical instructions according to the present embodiments.

The computer system 400 may also include random access memory (RAM) 408, which may be SRAM, DRAM, SDRAM, or the like. The computer system 400 may utilize RAM 408 to store the various data structures used by a software application. The computer system 400 may also include read only memory (ROM) 406 which may be PROM, EPROM, EEPROM, optical storage, or the like. The ROM may store configuration information for booting the computer system 400. The RAM 408 and the ROM 406 hold user and system data.

The computer system 400 may also include an input/output (I/O) adapter 410, a communications adapter 414, a user interface adapter 416, and a display adapter 422. The I/O adapter 410 and/or the user interface adapter 416 may, in certain embodiments, enable a user to interact with the computer system 400. In a further embodiment, the display adapter 422 may display a graphical user interface associated with a software or web-based application. For example, the display adapter 422 may display menus allowing an administrator to input data on the server 202 through the user interface adapter 416.

The I/O adapter 410 may connect one or more storage devices 412, such as one or more of a hard drive, a compact disk (CD) drive, a floppy disk drive, and a tape drive, to the computer system 400. The communications adapter 414 may be adapted to couple the computer system 400 to the network 208, which may be one or more of a LAN, WAN, and/or the Internet. The communications adapter 414 may be adapted to couple the computer system 400 to a storage device 412a. The user interface adapter 416 couples user input devices, such as a keyboard 420 and a pointing device 418, to the computer system 400. The display adapter 422 may be driven by the CPU 402 to control the display on the display device 424.

The applications of the present disclosure are not limited to the architecture of computer system 400. Rather the computer system 400 is provided as an example of one type of computing device that may be adapted to perform the functions of a server 202. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a freight waybill (FWB) message for an air waybill for a shipment;
determining if the air waybill has a special handling code indicating the air waybill is an e-freight air waybill;
when the air waybill is an e-freight air waybill processing the e-freight air waybill according to the received FWB message without locking the e-freight air waybill; and
locking the e-freight air waybill when the shipment is accepted by a receiver.

2. The method of claim 1, in which the special handling code comprises at least one of an e-Freight Air Waybill with Paper Document (EAP) and an e-Freight Air Waybill without Paper Document (EAW).

3. The method of claim 1, in which processing the e-freight air waybill comprises recording the FWB message on the e-freight air waybill.

4. The method of claim 3, in which the FWB message is recorded in an air waybill history for the e-freight air waybill.

5. The method of claim 3, further comprising recording additional FWB messages on the e-freight air waybill before locking the e-freight air waybill.

6. The method of claim 1, in which after locking the e-freight air waybill the e-freight air waybill represents a legal air waybill.

7. The method of claim 1, further comprising performing automatic export quality assurance (EQA) on the e-freight air waybill.

8. A computer program product, comprising:
a computer-readable medium comprising:
code to receive a freight waybill (FWB) message for an air waybill for a shipment;
code to determine if the air waybill has a special handling code indicating the air waybill is an e-freight air waybill;
code to, when the air waybill is an e-freight air waybill, process the e-freight air waybill according to the received FWB message without locking the e-freight air waybill; and
code to lock the e-freight air waybill when the shipment is accepted by a receiver.

9. The computer program product of claim 8, in which the medium further comprises code to identify at least one of an e-Freight Air Waybill with Paper Document (EAP) and an e-Freight Air Waybill without Paper Document (EAW).

10. The computer program product of claim 8, in which the medium further comprises code to record the FWB message on the e-freight air waybill.

11. The computer program product of claim 10, in which the medium further comprises code to store an air waybill history for the e-freight air waybill.

12. The computer program product of claim 10, in which the medium further comprises code to record additional FWB messages on the e-freight air waybill before locking the e-freight air waybill.

13. The computer program product of claim 8, in which the medium further comprises code to perform automatic export quality assurance (EQA) on the e-freight air waybill.

14. An apparatus, comprising:
at least one processor and a memory coupled to the at least one processor, in which the at least one processor is configured:
to receive a freight waybill (FWB) message for an air waybill for a shipment;
to determine if the air waybill has a special handling code indicating the air waybill is an e-freight air waybill;
to, when the air waybill is an e-freight air waybill, process the e-freight air waybill according to the received FWB message without locking the e-freight air waybill; and
to lock the e-freight air waybill when the shipment is accepted by a receiver.

15. The apparatus of claim 14, in which the at least one processor is further configured to identify at least one of an e-Freight Air Waybill with Paper Document (EAP) and an e-Freight Air Waybill without Paper Document (EAW) on the e-freight air waybill.

16. The apparatus of claim 14, in which the at least one processor is further configured to record the FWB message on the e-freight air waybill.

17. The apparatus of claim 14, in which the at least one processor is further configured to store an air waybill history for the e-freight air waybill in the memory.

18. The apparatus of claim 14, in which the at least one processor is further configured to record additional FWB messages on the e-freight air waybill before locking the e-freight air waybill.

19. The apparatus of claim 14, in which the at least one processor is further configured to perform automatic export quality assurance (EQA) on the e-freight air waybill.

20. The apparatus of claim 14, in which the at least one processor is further configured to create a status-only air waybill when the received FWB message is associated with an air waybill not stored in memory.
